(19) United States
(12) Patent Application Publication
(10) Pub. No.: US 2014/0337190 A1
(43) Pub. Date: Nov. 13, 2014

(54) Purchase Order Matching

(71) Applicant: Kaoru Watanabe, Sunnyvale, CA (US)

(72) Inventor: Kaoru Watanabe, Sunnyvale, CA (US)

(73) Assignee: RICOH COMPANY, LTD., Tokyo (JP)

(21) Appl. No.: 13/891,047

(22) Filed: May 9, 2013

(51) Int. Cl. G06Q 30/04

(52) U.S. Cl. CPC G06Q 30/04
USPC 705/34

(57) ABSTRACT

An approach is provided for processing invoices that includes the use of a purchase order system to verify information on the invoices. Invoice image data that represents an invoice is received and one or more text fields represented in the invoice image data are obtained. The one or more text fields represented in the invoice image data are compared to purchase order data from a purchase order system. If the one or more text fields represented in the invoice image data do not match the purchase order data from the purchase order system, then the one or more text fields represented in the invoice image data are designated for special processing. If the one or more text fields represented in the invoice image data match the purchase order data from the purchase order system, then the invoice is designated as verified and the one or more text fields are transmitted to an accounting system for processing.

### FIELD

Embodiments relate to invoice processing and, more particularly, to automatically verifying invoice data with data from a purchase order system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Despite the proliferation of electronic accounting systems, some aspects of accounting are still performed manually. For example, when a business organization issues purchase orders for products or services and receives invoices from a vendor, the invoices are sometimes manually verified. For example, accounting department personnel may access a purchase order system and compare product or service description, quantity and price information on a printed invoice to data stored in a purchase order system. If all of the data matches, then the invoice is approved for payment and data from the invoice is entered into an accounting system to enable payment to be made to the vendor. If some of the data on the invoice does not match corresponding data in the purchase order system however, then the invoice is designated as requiring special processing. Special processing may take many forms, depending upon a particular situation. For example, in a situation where an invoice indicates that 100 ordered items were delivered, but the purchase order system indicates that only 80 of the ordered items were delivered, then payment for delivery of the 80 ordered items may be authorized, but not for the remaining 20 items not yet delivered. Manual verification of invoices is labor intensive and prone to error.

### SUMMARY

An approach for verifying invoices includes retrieving invoice image data that represents an invoice. One or more text fields that are represented in the invoice image data are obtained from the invoice image data. The one or more text fields represented in the invoice image data are verified by comparing the one or more text fields to purchase order data from a purchase order system. In response to determining that the one or more text fields represented in the invoice image data do not match the purchase order data from the purchase order system, then the one or more text fields represented in the invoice image data are designated for special processing. In response to determining that the one or more text fields represented in the invoice image data match the purchase order data from the purchase order system, then the invoice is designated as verified and the one or more text fields are transmitted to an accounting system for processing. The approach may be implemented by instructions stored on one or more computer-readable media, by one or more devices, or by one or more computer-implemented methods.

### BRIEF DESCRIPTION OF THE DRAWINGS

In the drawings:

FIG. 1 is a block diagram that depicts an arrangement for verifying invoices.

FIG. 2 is a flow diagram that depicts and approach for automatically verifying invoices using purchase order data.

FIGS. 3A-3D depict an example graphical user interface generated by invoice verification process that allows a user to view information about and/or participate in the verification processing.

FIG. 4 is a message ladder diagram that depicts an example exchange of messages between the elements of FIG. 1 to verify invoice data.

FIG. 5 is a block diagram that depicts a computer system upon which an embodiment may be implemented.

### DETAILED DESCRIPTION

In the following description, for the purposes of explanation, numerous specific details are set forth in order to provide a thorough understanding of the embodiments. It will be apparent, however, that the embodiments may be practiced without these specific details. In other instances, well-known structures and devices are shown in block diagram form in order to avoid unnecessarily obscuring the embodiments.

I. OVERVIEW

II. SYSTEM ARCHITECTURE

III. INVOICE VERIFICATION

IV. IMPLEMENTATION MECHANISMS

### I. Overview

An approach is provided for processing invoices that includes the use of a purchase order system to verify information on the invoices. Invoice image data that represents an invoice is received and one or more text fields represented in the invoice image data are obtained. The one or more text fields represented in the invoice image data are compared to purchase order data from a purchase order system. If the one or more text fields represented in the invoice image data do not match the purchase order data from the purchase order system, then the one or more text fields represented in the invoice image data are designated for special processing. If the one or more text fields represented in the invoice image data match the purchase order data from the purchase order system, then the invoice is designated as verified and the one or more text fields are transmitted to an accounting system for processing. This approach allows electronic invoice data to be automatically verified using information from a purchase order system, which may reduce the amount of human labor required to verify invoices and reduce the number of errors. The approach may also reduce costs associated with manual entry of invoice data into accounting systems.

### II. System Architecture

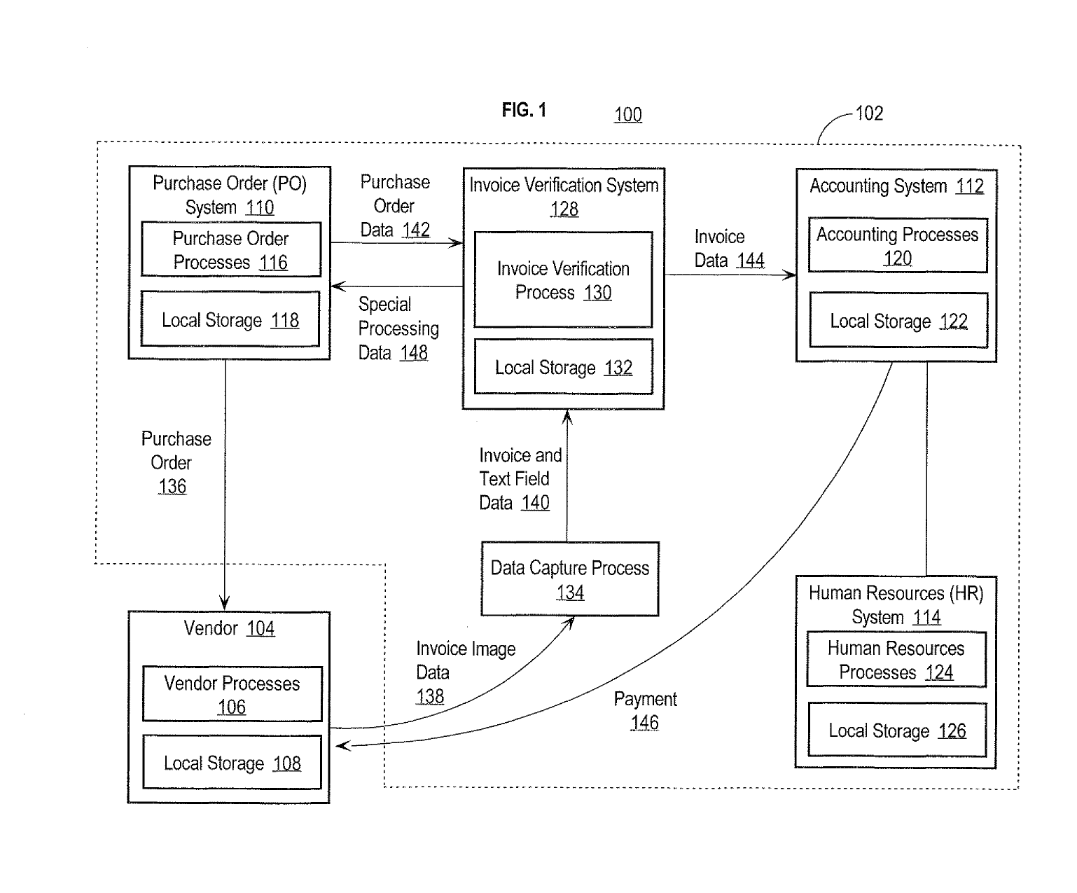

FIG. 1 is a block diagram that depicts an arrangement 100 for verifying invoices. Arrangement 100 includes an arrangement 102 of example electronic systems of a business organization and a vendor 104. In the following examples, the business organization is purchasing goods and/or services from the vendor 104. In the example depicted in FIG. 1, vendor 104 includes vendor processes 106 and local storage 108. Vendor processes 106 include, for example, a purchase order process for processing purchase orders, an invoice process for generating invoices, an inventory management process, etc. Local storage 108 may include any type of volatile or non-volatile storage that may vary depending upon a particular implementation. Vendor 104 may include other elements and processes, depending upon a particular implementation.

In the example depicted in FIG. 1, arrangement 102 includes a purchase order (PO) system 110, an accounting system 112 and a human resources (HR) system 114. Arrangement 102 may include additional elements and processes or fewer elements and processes than those depicted in FIG. 1, depending upon a particular implementation and the approaches described herein are not limited to any particular electronic systems of a business organization. PO system 110 includes one or more purchase order processes 116 and local storage 118. Purchase order processes 116 are configured to generate purchase orders for goods and/or services purchased by the business organization and to allow entry of various data related to purchase orders. For example, purchase order processes 116 may provide a graphical user interface that allows entry of information pertaining to purchase orders, such as purchase order information, purchase order status information, purchase order approval information, etc. Local storage 118 may include any type of volatile or non-volatile storage for storing purchase order and other information. Accounting system 112 includes one or more accounting processes 120 and local storage 122. Accounting processes 120 are configured to process invoices and provide for payment of vendor invoices. Accounting processes 120 may include a wide variety of other processes, depending upon a particular arrangement, for example, accounts payable and accounts receivable processes. HR system 114 includes one or more human resources processes 124 and local storage 126. Human resources processes 124 may include a wide variety of human resources processes that may vary depending upon a particular implementation and the approaches described herein are not limited to any particular type of human resources processes.

Arrangement 102 includes an invoice verification system 128 that includes an invoice verification process 130 and local storage 132. As described in more detail hereinafter, invoice verification system 128 is configured generally to verify electronic invoice data using data from PO system 110. This may include determining whether particular text fields identified in electronic invoice data are correct with respect to data maintained by PO system 110. Electronic invoices that have text fields that are determined to be correct by the invoice verification system 128 are designated as verified and provided to accounting system 112 for processing. Electronic invoices that have text fields that are determined to not be correct by invoice verification system 128 are designated for special processing. As described in more detail hereinafter, data capture process 134 is configured to process electronic invoice data, for example, invoice image data, and identify one or more text fields represented in the electronic invoice data. For example, vendor 104 may generate paper invoices that are scanned, for example, by a scanner or multi-function peripheral (MFP), to generate electronic invoice data that is provided to data capture process 134. Alternatively, vendor 104 may generate invoices in electronic form and in this situation, the electronic invoice data is provided by vendor 104 to data capture process 134. Although depicted in FIG. 1 as a single process for purposes of explanation only, data capture process 134 may comprise any number of processes, depending upon a particular implementation. For example, data capture process 134 may include, as one example, an optical character recognition process for converting invoice image data into text data. According to one embodiment, data capture process 134 includes a data capture engine for identifying text fields in invoice image data. One such example is Abbyy Flexicapture, by ABBYY USA.

The various elements and processes depicted in FIG. 1 may communicate with each other via direct communications links or via one or more wired or wireless networks, for example, one or more local area networks (LANs), wide area networks (WANs) or other networks, including the Internet. Communications between the elements depicted in FIG. 1 may be made using secure communications. In addition, the various elements and processed depicted in FIG. 1 may execute on a common computing platform and computing device, or on different computing platforms and computing devices, depending upon a particular implementation. As one example, data capture process 134 and invoice verification system 128 may be integrated into PO system 110 and/or accounting system 112. As another example, data capture process 134 and invoice verification system 128 may be implemented in a network and accessed as a network service, for example, as a cloud service or cloud application.

### III. Invoice Verification

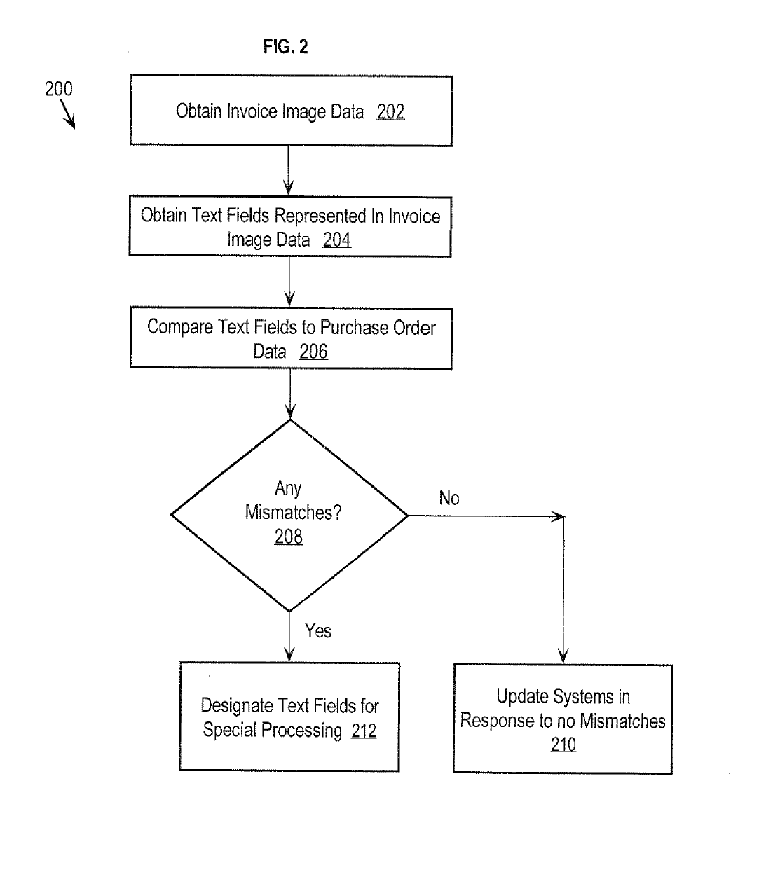

FIG. 2 is a flow diagram 200 that depicts and approach for automatically verifying invoices using purchase order data, according to an embodiment. Reference is also made to elements depicted in FIG. 1. In this example, it is presumed that a business entity “ABC” has ordered, from vendor 104, 100 widgets at a price of $1.00 per widget and has issued a purchase order 136 to vendor 104 for the widgets. Various electronic systems of ABC are represented by arrangement 102. The purchase order 136 may be in paper form or electronic form. Vendor 104 has delivered the 100 widgets to ABC and issued to ABC an invoice for the 100 widgets. The invoice references ABC's purchase order number and also identifies the 100 widgets at a price of $1.00 each, a shipping charge of $5, and a total charge of $105.

In step 202, invoice image data 138 is obtained that represents the invoice issued by vendor 104. The invoice image data may be generated based upon a paper invoice issued by vendor 104 that is then scanned, for example, by a scanner or multi-function peripheral (MFP). Alternatively, vendor 104 may have issued an electronic invoice.

In step 204, text fields are retrieved from the invoice image data. For example, data capture process 134 may process the invoice image data 138 to retrieve one or more text fields contained in the invoice image data. This may include various types of processing, such as OCR processing and data capture processing. In this example, data capture process 134 identifies text fields in the invoice image data. The particular text fields identified in invoice image data may vary depending upon a particular implementation and the approaches described herein are not limited to any particular text fields. Example text fields include, without limitation, vendor name, invoice number, invoice date, purchase order number, item name, item quantity, item price, shipping charge, total charge, other line items, etc. Data capture process 134 may provide invoice and text field data 140 to the invoice verification system 128.

In step 206, the text fields retrieved from the invoice image data are compared to purchase order data. This may include comparing values contained in text fields to purchase order data from PO system 110. The invoice verification system 128 may obtain purchase order data 142 from PO system 110, for example, by requesting purchase order data 142 for the purchase order number or invoice number obtained by data capture process 134 from the invoice image data 138. The invoice verification system 128 then compares the purchase order data obtained from PO system 110 to the values contained in the text fields obtained by the data capture process 134.

In step 208, a determination is made whether any mismatches exist between the text fields obtained from the invoice image data and the purchase order data obtained from the PO system 110. In this example, a “mismatch” may occur when one or more text fields obtained from the invoice image data do not match corresponding data obtained from the PO system 110. For example, the value of a quantity obtained by data capture process 134 from the invoice image data 138 may not match the quantity for the purchase order 136 issued by PO system 110. This type of mismatch indicates that there is a discrepancy in the quantity of widgets that ABC ordered and for which ABC was invoiced by vendor 104. In some embodiments, a mismatch may be determined to exist when at least a specified number of data items, i.e., text fields, do not match the corresponding data from the PO system 110. In other embodiments, priorities or designations may be assigned to invoice data and a mismatch determined when one or more text fields having a specified priority or designation do not match corresponding data obtained from the PO system 110. For example, text fields such as quantity, price and total cost may be assigned the highest priority or be assigned a special designation, so that if any of these text fields do not match the corresponding data obtained from the PO system 110, then a mismatch is determined to have occurred. Other text fields, for example, a general information field or other non-essential information fields may be assigned a lower priority, such that if these fields do not match the corresponding data obtained from the PO system 110, then a mismatch will not be determined to have occurred.

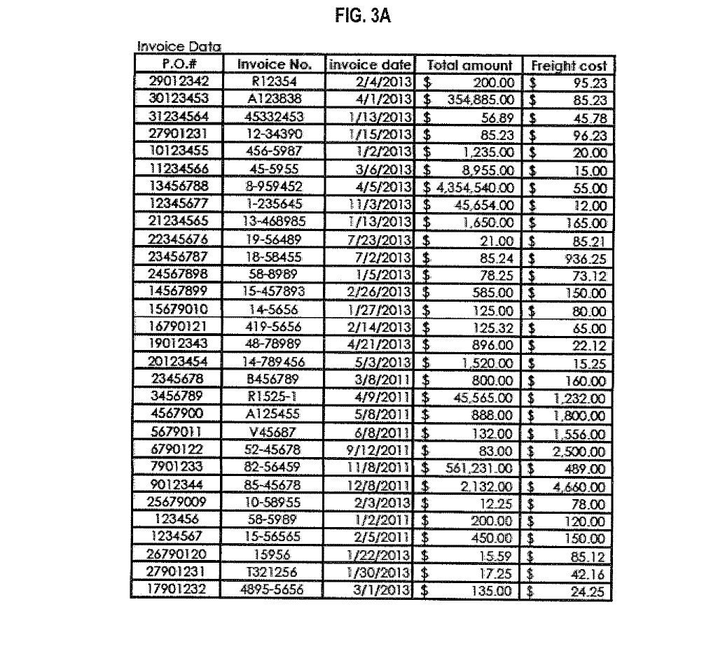

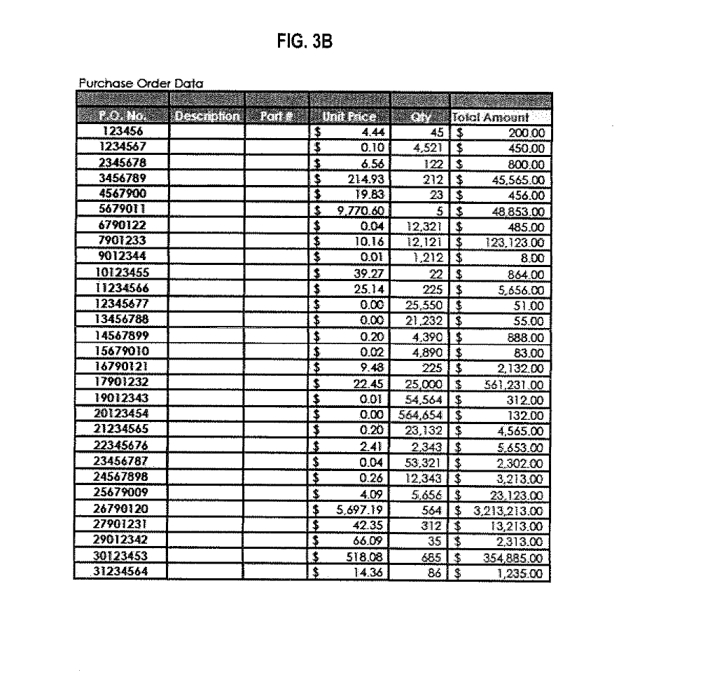

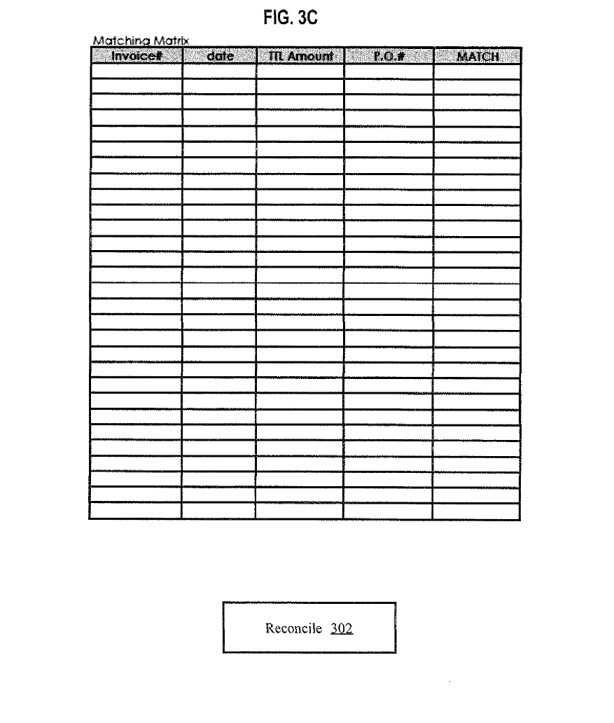

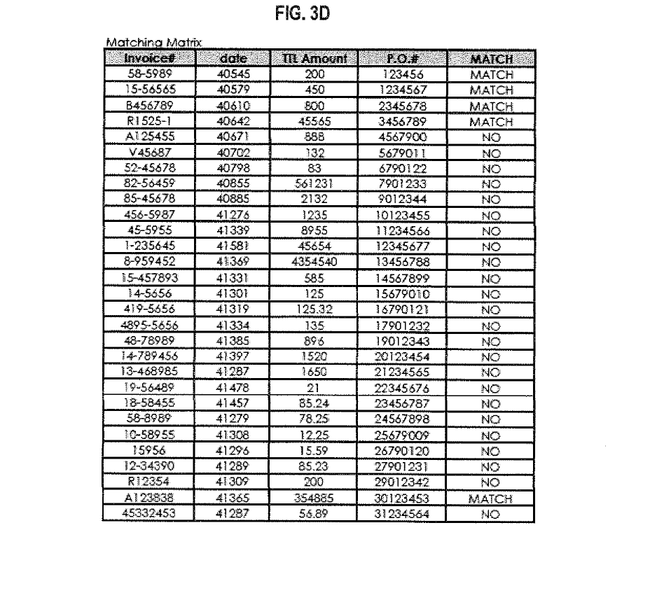

The comparing of the text fields retrieved from the invoice image data to the purchase order data may be performed automatically by invoice verification system 128, for example, by invoice verification process 130. FIGS. 3A-3D depict an example graphical user interface generated by invoice verification process 130 that allows a user to view information about and/or participate in the verification processing. FIG. 3A is a diagram that depicts a portion of a graphical user interface that displays a table of invoice data that has been obtained by data capture process 134 from invoice image data 138. The table depicted in FIG. 3A includes data for multiple invoices and includes, a purchase order number, an invoice number, an invoice date, a total amount and a freight cost. FIG. 3B is a diagram that depicts a table of purchase order data maintained by PO system 110. The table depicted in FIG. 3B includes data for multiple purchase orders and includes, a purchase order number, a unit price, a quantity and a total amount. The purchase order data may also include a description and part #, although this information is not included in the table of FIG. 3B for purposes of explanation. FIG. 3C is a diagram that depicts a matching matrix that is configured to reconcile invoice data obtained by the data capture process 134 using purchase order data from PO system 110. The diagram of FIG. 3C does not include any results of the reconciliation because reconciliation has not yet been requested. In this example, a graphical user interface object in the form of a Reconcile 302 button is provided. Upon selection of the Reconcile 302 button, reconciliation is performed and the results are displayed, as depicted in FIG. 3D. In FIG. 3D, the matching matrix has been populated with the results of reconciling invoice data obtained by the data capture process 134 using purchase order data from PO system 110. As depicted in FIG. 3D, no mismatches have been determined for some of the invoices, as indicated by a Match value of “MATCH”. Invoices for which one or more data items obtained by data capture process 134 do not match purchase order data from PO system 110 have a Match value of “NO”. As described in more detail hereinafter, invoices that are determined to not have any mismatches, as indicated by the Match value of “MATCH”, are provided to the accounting system 112 for processing. Invoices that are determined to have one or more mismatches, as indicated by the Match value of “NO”, are identified for special processing, as described in more detail hereinafter.

If, in step 208, a determination is made that no mismatches exist, then in step 210, systems are updated in response to this determination. This may include updating various systems, depending upon a particular implementation, and the approaches described herein are not limited to updating any particular type of system. As one example, the invoice data 144 (text data) obtained from the invoice image data may be provided to accounting system 112. This eliminates manual entry of invoice data from a printed invoice, which can reduce costs and reduce the likelihood of errors attributable to manual data entry. As another example, a status of the purchase order may be updated in the PO system 110, the accounting system 112, or both the PO system 110 and the accounting system 112. As one example, the status of the purchase order may be changed to “billed”. Accounting system 112 may also make payment 146 to the vendor 104. The invoice image data may also be provided to the accounting system 112.

If, in step 208, a determination is made that one or more mismatches exist, then in step 212, the one or more text fields are designated for special processing. This may include, for example, invoice verification system 128 generating and providing to PO system 110 special processing data 148. Special processing data 148 may identify an invoice and text fields that did not match the corresponding data obtained from the PO system 110 to allow corrective action to be taken by accounting personnel. Example corrective actions include, without limitation, requesting the vendor 104 to issue a corrected invoice, correcting any mismatches on the invoice, or changing purchase order data maintained by the PO system 110. Other example corrective actions include, without limitation, determining whether a separate purchase order (and corresponding invoice) should be generated for a portion of goods and/or services that were received. Corrective action may also include, for example, generating and transmitting an email or other type of message notification to notify one or more recipients that a mismatch exists for a particular invoice. Results of the comparison made in Step 206 may be recorded, for example, in report data stored on local storage 132. The report data may indicate that no mismatches were found, or in situations where mismatches are identified, the report data may indicate the particular mismatches that were identified. For example, the report data may specify particular text fields where mismatches occurred.

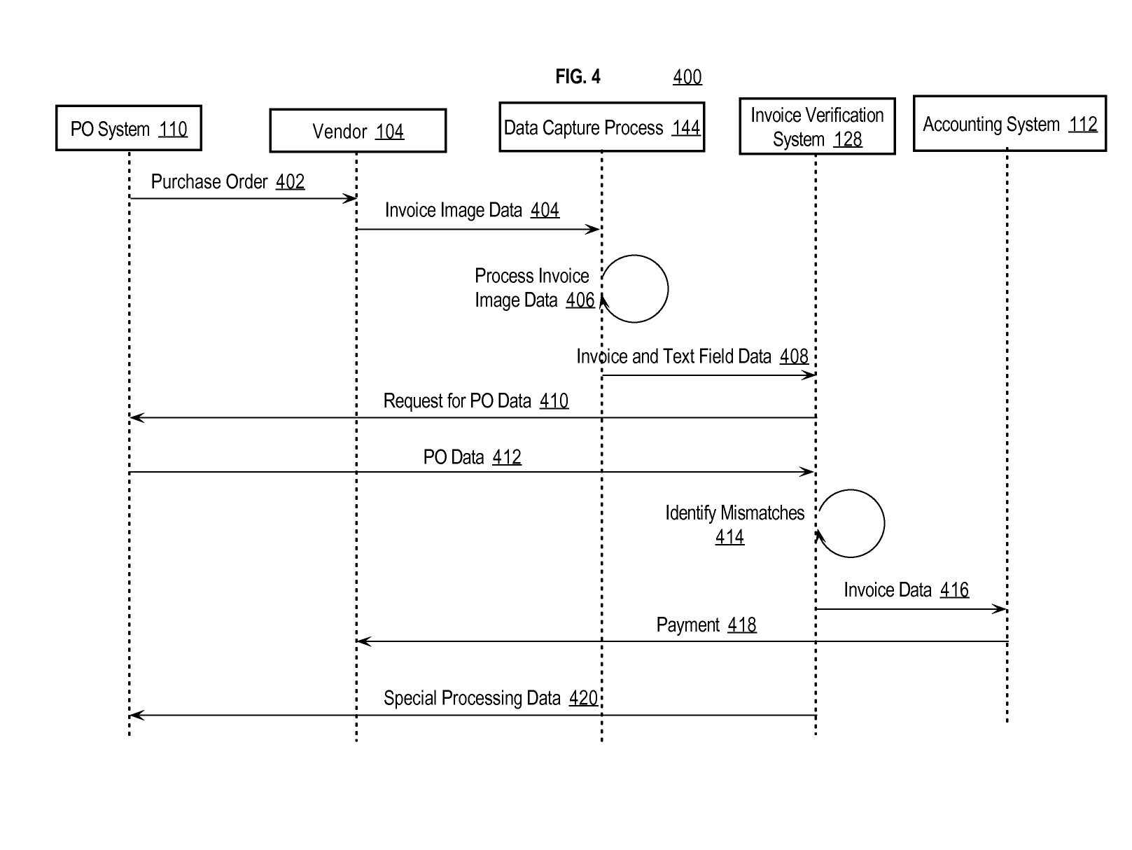

FIG. 4 is a message ladder diagram 400 that depicts an example exchange of messages between the elements of FIG. 1 to verify invoice data according to an embodiment. As in the prior example, this example assumes that the business entity ABC has ordered widgets from vendor 104. In step 402, ABC generates and provides a purchase order to vendor 104. Vendor 104 delivers the widgets to ABC and generates an invoice. In step 404, invoice image data is provided to ABC and processed by the data capture process 134. This may occur in several ways, depending upon the type of invoice generated by the vendor 104. For example, if vendor 104 generates a paper invoice, then the paper invoice may be scanned by a scanner or MFP to generate invoice image data. Alternatively, vendor 104 may generate and provide to ABC invoice image data. Embodiments are not limited to situations in which the invoice image data is provided directly from vendor 104 to the data capture process 134. Invoice image data may be stored on a network service and then retrieved by the data capture process 134 from the network service. For example, paper invoices may be scanned and the invoice image data stored at a particular network service or at a network storage location. Alternatively, vendor 104 may generate invoice image data and cause the invoice image data to be stored at the particular network service or at the network storage location. Data capture process 134 then retrieves the invoice image data from the particular network service or from the network storage location. One example of a network storage location is a particular server within a business organization.

In step 406, the data capture process 134 processes the invoice image data to obtain text fields contained in the invoice image data, as previously described herein. In step 408, data capture process 134 provides the invoice and text field data to the invoice verification system 128. In step 410, invoice verification system 128 generates and transmits to PO system 110 a request for PO data. In response to the request, in step 412, the PO system 110 provides PO data to invoice verification system 128. The request includes sufficient information for the PO system 110 to provide the PO data to the invoice verification system 128. For example, the request may include a purchase order number obtained by the data capture process 134 from the invoice image data in step 406. If the purchase order number is not available, or simply as an alternative, it may be possible for the request to use other information obtained from the invoice image data. For example, information that identifies the ordered product or service, quantity and price may be included in the request and used by the PO system 110 to identify a corresponding purchase order.

In step 414, mismatches are identified. As previously described herein, invoice verification system 128 compares one or more data in the purchase order data received from the PO system 110 to the text field data obtained by the data capture process 134 to determine whether a mismatch exists between the invoice issued by the vendor 104 and the purchase order data maintained by ABC.

If no mismatches are identified, then in step 416, the invoice verification system 128 provides invoice data to the accounting system 112. The invoice data may include the invoice image data, as well as the text data, e.g., text fields, obtained by data capture process 134 in step 406. The invoice data does not necessarily have to be provided directly from invoice verification system 128 to the accounting system 112. For example, invoice verification system 128 may cause the invoice data to be stored at a particular network service or at a network storage location, which may be the same or different than the network service or network storage location use to store the invoice image data, as previously described herein. Accounting system 112 then retrieves the invoice data from the particular network service or from the network storage location. In step 418, the accounting system 112 makes a payment of the invoice to the vendor 104. As previously described herein, in the situation where no mismatches are identified, then other functionality may also be performed. For example, a status of the purchase order may be updated, e.g., changed to “billed,” in the PO system 110, the accounting system 112, or both the PO system 110 and the accounting system 112. As one example, the status of the purchase order may be changed to “billed”.

If mismatches are identified, then in step 420, special processing data is generated and provided to the PO system 110. As previously described herein, the special processing data may identify an invoice and text fields that did not match the corresponding data obtained from the PO system 110 to allow investigation by accounting personnel.

### IV. Implementation Mechanisms

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

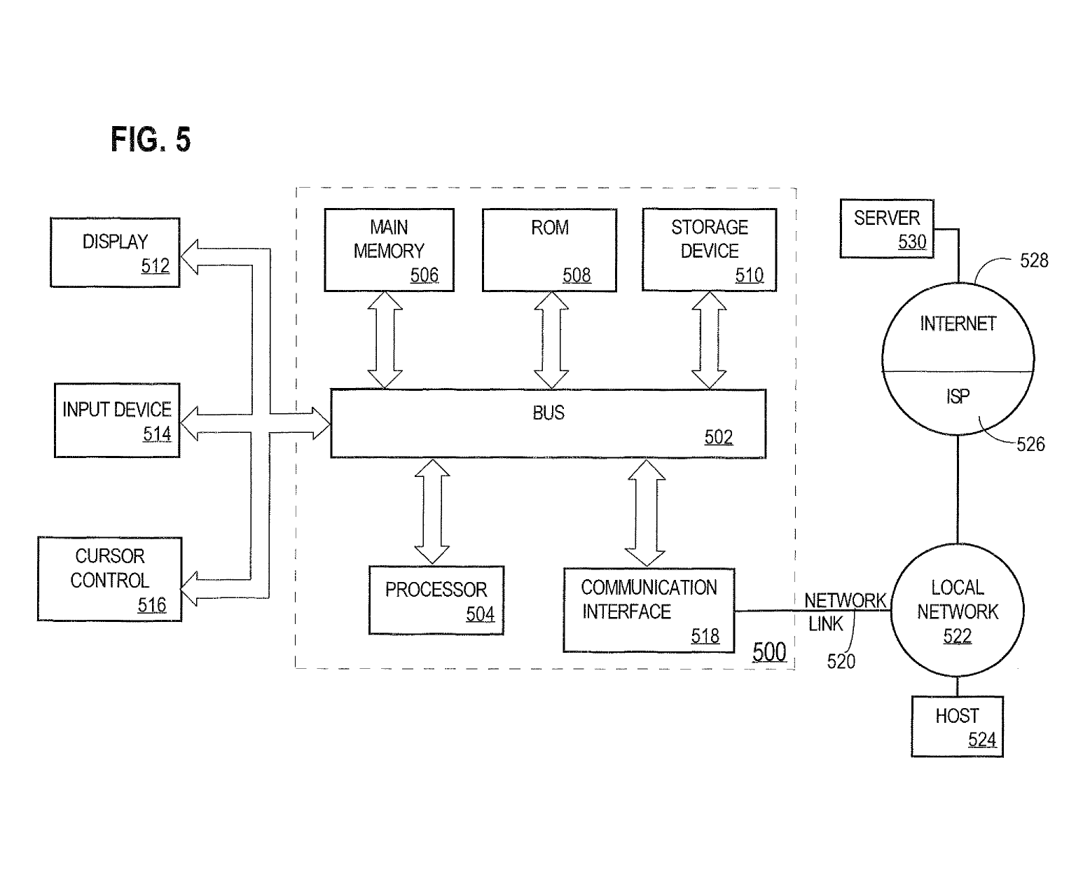

For example, FIG. 5 is a block diagram that depicts a computer system 500 upon which an embodiment may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. One or more computer-readable storage media storing instructions which, when processed by one or more processors, cause:
retrieving invoice image data that represents an invoice;
obtaining one or more text fields represented in the invoice image data;
verifying, at one or more computing devices, the one or more text fields represented in the invoice image data by comparing the one or more text fields represented in the invoice image data to purchase order data from a purchase order system;
in response to determining that the one or more text fields represented in the invoice image data do not match the purchase order data from the purchase order system, then at the one or more computing devices, designating the one or more text fields represented in the invoice image data for special processing; and
in response to determining that the one or more text fields represented in the invoice image data match the purchase order data from the purchase order system, then at the one or more computing devices:
designating the invoice as verified, and
transmit the one or more text fields to an accounting system for processing.

2. The one or more computer-readable storage media of claim 1, wherein obtaining one or more text fields represented in the invoice image data includes causing a data capture engine to process the invoice image data.

3. The one or more computer-readable storage media of claim 1, further storing additional instructions which, when processed by the one or more processors, causes:
providing to the purchase order system at least one text field from the one or more text fields, wherein the at least one text field identifies one or more purchase orders, and
receiving the purchase order data from the purchase order system.

4. The one or more storage media of claim 1, further storing additional instructions which, when processed by the one or more processors, causes:
in response to determining that the one or more text fields represented in the invoice image data match the purchase order data from the purchase order system, causing, in the purchase order system, purchase order data that corresponds to the invoice to be revised to indicate that the purchase order is at least ready to be billed.

5. The one or more computer-readable storage media of claim 1, further storing additional instructions which, when processed by the one or more processors, causes:
in response to at least one or more particular text fields represented in the invoice image data matching the purchase order data from the purchase order system, causing data in an accounting system to be updated to indicate that the invoice has been verified and is ready to be paid.

6. The one or more computer-readable storage media of claim 1, further storing additional instructions which, when processed by the one or more processors, causes:
generating one or more graphical user interface objects which, when displayed on a display device, provide a visual indication to a user whether the one or more text fields represented in the invoice image data match the purchase order data from the purchase order system.

7. The one or more computer-readable storage media of claim 1, further storing additional instructions which, when processed by the one or more processors, causes:
in response to determining that the one or more text fields represented in the invoice image data do not match the purchase order data from the purchase order system, causing a notification to be generated and transmitted, wherein the notification at least identifies that the invoice was not successfully verified.

8. An apparatus comprising:
one or more processors; and
one or more memories storing instructions which, when processed by the one or more processors, cause:
retrieving invoice image data that represents an invoice;
obtaining one or more text fields represented in the invoice image data;
verifying, at the apparatus, the one or more text fields represented in the invoice image data by comparing the one or more text fields represented in the invoice image data to purchase order data from a purchase order system;
in response to determining that the one or more text fields represented in the invoice image data do not match the purchase order data from the purchase order system, then at the apparatus, designating the one or more text fields represented in the invoice image data for special processing; and
in response to determining that the one or more text fields represented in the invoice image data match the purchase order data from the purchase order system, then at the apparatus:
designating the invoice as verified, and
transmit the one or more text fields to an accounting system for processing.

9. The apparatus of claim 8, wherein obtaining one or more text fields represented in the invoice image data includes causing a data capture engine to process the invoice image data.

10. The apparatus of claim 8, wherein the one or more memories further store additional instructions which, when processed by the one or more processors, causes:
providing to the purchase order system at least one text field from the one or more text fields, wherein the at least one text field identifies one or more purchase orders, and
receiving the purchase order data from the purchase order system.

11. The apparatus of claim 8, wherein the one or more memories further stores additional instructions which, when processed by the one or more processors, causes:
in response to determining that the one or more text fields represented in the invoice image data match the purchase order data from the purchase order system, causing, in the purchase order system, purchase order data that corresponds to the invoice to be revised to indicate that the purchase order is at least ready to be billed.

12. The apparatus of claim 8, wherein the one or more memories further store additional instructions which, when processed by the one or more processors, causes:
in response to at least one or more particular text fields represented in the invoice image data matching the purchase order data from the purchase order system, causing data in an accounting system to be updated to indicate that the invoice has been verified and is ready to be paid.

13. The apparatus of claim 8, wherein the one or more memories further store additional instructions which, when processed by the one or more processors, causes:
generating one or more graphical user interface objects which, when displayed on a display device, provide a visual indication to a user whether the one or more text fields represented in the invoice image data match the purchase order data from the purchase order system.

14. The apparatus of claim 8, wherein the one or more memories further store additional instructions which, when processed by the one or more processors, causes:
in response to determining that the one or more text fields represented in the invoice image data do not match the purchase order data from the purchase order system, causing a notification to be generated and transmitted, wherein the notification at least identifies that the invoice was not successfully verified.

15. A computer-implemented method comprising:
retrieving invoice image data that represents an invoice;
obtaining one or more text fields represented in the invoice image data;
verifying, at one or more computing devices, the one or more text fields represented in the invoice image data by comparing the one or more text fields represented in the invoice image data to purchase order data from a purchase order system;
in response to determining that the one or more text fields represented in the invoice image data do not match the purchase order data from the purchase order system, then at the one or more computing devices, designating the one or more text fields represented in the invoice image data for special processing; and
in response to determining that the one or more text fields represented in the invoice image data match the purchase order data from the purchase order system, then at one or more computing devices:
designating the invoice as verified, and
transmit the one or more text fields to an accounting system for processing.

16. The computer-implemented method of claim 15, wherein obtaining one or more text fields represented in the invoice image data includes causing a data capture engine to process the invoice image data.

17. The computer-implemented method of claim 15, wherein the one or more memories further store additional instructions which, when processed by the one or more processors, causes:
providing to the purchase order system at least one text field from the one or more text fields, wherein the at least one text field identifies one or more purchase orders, and
receiving the purchase order data from the purchase order system.

18. The computer-implemented method of claim 15, further comprising:
in response to determining that the one or more text fields represented in the invoice image data match the purchase order data from the purchase order system, causing, in the purchase order system, purchase order data that corresponds to the invoice to be revised to indicate that the purchase order is at least ready to be billed.

19. The computer-implemented method of claim 15, further comprising:
in response to at least one or more particular text fields represented in the invoice image data matching the purchase order data from the purchase order system, causing data in an accounting system to be updated to indicate that the invoice has been verified and is ready to be paid.

20. The computer-implemented method of claim 15, further comprising:
generating one or more graphical user interface objects which, when displayed on a display device, provide a visual indication to a user whether the one or more text fields represented in the invoice image data match the purchase order data from the purchase order system.
